(19) United States
(12) Patent Application Publication
(10) Pub. No.: US 2013/0113713 A1
(43) Pub. Date: May 9, 2013

(54) IMOD ART WORK FOR DISPLAYS

(71) Applicant: Marek Mienko, San Jose, CA (US)

(72) Inventor: Marek Mienko, San Jose, CA (US)

(73) Assignee: QUALCOMM MEMS TECHNOLOGIES, INC., San Diego, CA (US)

(21) Appl. No.: 13/289,986

(22) Filed: Nov. 4, 2011

(51) Int. Cl. G06F 3/041; H01J 9/24; G02B 26/02

(52) U.S. Cl. 345/173; 359/291; 445/24

(57) ABSTRACT

Static IMOD structures may be formed in a border area of a substrate. In some implementations, conductive layers such as an absorber or a reflector of a static IMOD may be used to make electrical connections from the electrodes of a touch sensor to the flex cable or controller of the touch sensor. In some implementations, static IMODs may be configured to provide a border with a single, uniform color, whereas in other implementations static IMODs may be configured to provide artwork for the substrate. A variety of images and/or patterns of colors may be formed using the static IMODs. Some such static IMODs may be configured as numerous individual pixels or subpixels, such as red, blue and green subpixels.

### TECHNICAL FIELD

This disclosure relates to display devices, including but not limited to display devices that incorporate touch screens.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of

applications, and are anticipated to be used in improving existing products and creating new products, especially those with display capabilities.

The increased use of touch screens in handheld devices causes increased complexity and cost for modules that now include the display, the touch panel, a substrate for the touch panel and a cover glass. The substrate may be formed of any suitable substantially transparent material, such as glass, polymer, etc. Each piece of glass adds thickness and requires costly glass-to-glass bonding solutions for attachment to the neighboring substrates. These problems can be further exacerbated for reflective displays when a frontlight also needs to be integrated, adding to the thickness and cost of the module.

### SUMMARY

The systems, methods and devices of the disclosure each have several innovative aspects, no single one of which is solely responsible for the desirable attributes disclosed herein.

Some implementations described herein use static IMOD structures in the border area of a substrate. In some such implementations, the substrate may form, at least in part, a cover glass for a display. In some implementations, conductive layers of a static IMOD may be used to make electrical connections from the electrodes of a touch sensor formed on the substrate to the flex cable or controller of the touch sensor. In some implementations, static IMODs may be configured to provide at least a portion of a border with a single, uniform color, whereas in other implementations static IMODs may be configured to provide artwork for the substrate. In some implementations, the static IMODs may be formed only on one or two edges of the touch sensor, whereas in other implementations the static IMODs may substantially surround the touch sensor. A variety of images and/or patterns of colors may be formed using the static IMODs. Some such static IMODs may be configured as numerous individual pixels or subpixels, such as red, blue and green subpixels.

One innovative aspect of the subject matter described in this disclosure can be implemented in an apparatus that includes a substantially transparent substrate, a touch sensor electrode layer formed on a first area of the substantially transparent substrate and a layer of static interferometric modulators formed on the substantially transparent substrate in a border area along at least one edge of the first area. In some implementations, the border area may substantially surround the first area. At least some of the static interferometric modulators may not be configured for electrical communication with any electrode of the touch sensor electrode layer.

However, at least some of the static interferometric modulators may form a plurality of traces. Each of the traces may be configured for electrical communication with an individual electrode of the touch sensor electrode layer. The apparatus also may include a control system including a touch controller configured for electrical communication with the plurality of traces.

The apparatus may include a display and a memory device. The control system may include a processor configured to process image data and configured to communicate with the display, with the memory device and with the touch controller. The apparatus may include a driver circuit configured to send at least one signal to the display and a display controller configured to send at least a portion of the image data to the driver circuit. The substantially transparent substrate may form a cover over the display. The may include an input device configured to receive input data and to communicate the input data to the processor. The input device may include the touch sensor electrode layer. The apparatus may include an image source module configured to send the image data to the processor. The image source module may include a receiver, a transceiver and/or a transmitter.

The touch sensor electrode layer may overly the layer of static interferometric modulators. The layer of static interferometric modulators may overlap the touch sensor electrode layer.

The static interferometric modulators may include a first layer that is electrically conductive and partially optically absorptive, and a transparent layer that forms an optical cavity. A thickness of the transparent layer may determine a color of the static interferometric modulator. The static interferometric modulators may include a second layer that is reflective and conductive. The transparent layer may be formed of an oxide, such as a conductive oxide. The touch sensor electrode layer may be configured for electrical communication with a first portion of the second layer. The first layer may be grounded. For example, the first layer may be grounded to a second portion of the second layer that is not configured for electrical communication with the touch sensor electrode layer.

The touch sensor electrode layer may form at least part of the transparent layer. In some implementations, the static interferometric modulators may be configured to provide a single color. However, the static interferometric modulators may include first static interferometric modulators configured to provide a first color and second static interferometric modulators configured to provide a second color. The static interferometric modulators may be configured to provide a decorative pattern or image.

Another innovative aspect of the subject matter described in this disclosure can be implemented in a method that involves forming a touch sensor electrode layer on a first area of a substantially transparent substrate and forming a layer of static interferometric modulators on a first side of the substantially transparent substrate in a border area around the first area. The method may involve forming the touch sensor electrode layer on the first side of the substantially transparent substrate or on a second, opposite side of the substantially transparent substrate. Forming the layer of static interferometric modulators may involve forming a decorative pattern or image.

Forming the layer of static interferometric modulators may involve forming a plurality of traces. Each of the traces may be configured for electrical communication with an individual electrode of the touch sensor electrode layer. The method may involve configuring the substantially transparent substrate as a cover over a display. The method may involve configuring a touch controller for electrical communication with the plurality of traces. The method may involve configuring a display processor for electrical communication with the touch controller.

Another innovative aspect of the subject matter described in this disclosure can be implemented in a device that includes a substantially transparent substrate and a touch sensor electrode formed on a first area of the substantially transparent substrate. The device may include interferometric masking apparatus for interferometrically masking conductive lines formed in a border area around the first area. The interferometric masking apparatus may include a plurality of traces. Each of the traces may be configured for electrical communication with an individual electrode of the touch sensor electrode means. The static interferometric modulator apparatus may include optical cavity apparatus. A thickness of the optical cavity apparatus may determine a color of the static interferometric modulator apparatus.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of a display-side view of a substrate having touch sensor electrodes and routing wires formed thereon.

FIG. 9B shows an example of a view of a substrate from a side that is opposite to the side shown in FIG. 9A.

FIG. 10A shows an example of a cross-section through a substrate having static IMODs in a border area and an overlapping touch sensor electrode layer.

FIG. 10B shows an example of a graph of the spectral response of optical cavity layers configured to produce a black appearance.

FIG. 10C shows an example of a graph of color coordinates of optical cavity layers configured to reinforce a red color and a green color.

FIG. 10D shows an example of a cross-section through a substrate having static IMODs in a border area and a touch sensor electrode layer incorporated into an optical cavity layer of the static IMODs.

FIG. 10E shows an example of a cross-section through a substrate having static IMODs in a border area and overlapping a touch sensor electrode layer.

FIG. 11 shows an example of static IMODs forming a routing wire for a touch sensor electrode.

FIG. 12 shows an example of a flow diagram illustrating a manufacturing process for a touch sensor device.

FIG. 13 shows an example of a touch sensor device such as that shown in FIG. 10D mounted on a display glass.

FIGS. 14A and 14B show examples of system block diagrams illustrating a display device that includes a touch sensor as described herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

According to some implementations provided herein, static IMOD structures may be formed in the border area of a display. In some implementations, conductive layers of a static IMOD may be used to make electrical connections from the electrodes of a touch sensor to a flex cable or controller of the touch sensor. In some implementations, the static IMODs may be configured to provide a border with a single, uniform color, whereas in other implementations static IMODs may be configured to provide artwork for the substrate. A variety of images and/or patterns of colors may be formed using the static IMODs. Some such static IMODs may be configured as numerous individual pixels or subpixels, such as red, blue and green subpixels.

Particular implementations of the subject matter described in this disclosure can be implemented to realize one or more of the following potential advantages. Such implementations can be advantageous because the thickness of the static IMOD may be an order of magnitude less than the thickness of the paint or ink layer used in prior art devices. Multi-color border decorations made with ink require multiple printing steps. The resistance of the static IMOD may be lower than that of conductive inks. The lithography masks used to fabricate the static IMODs can offer better resolution than those used to fabricate prior art devices, thereby potentially increasing the density of the traces in the border area of the substrate and reducing the border's width.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

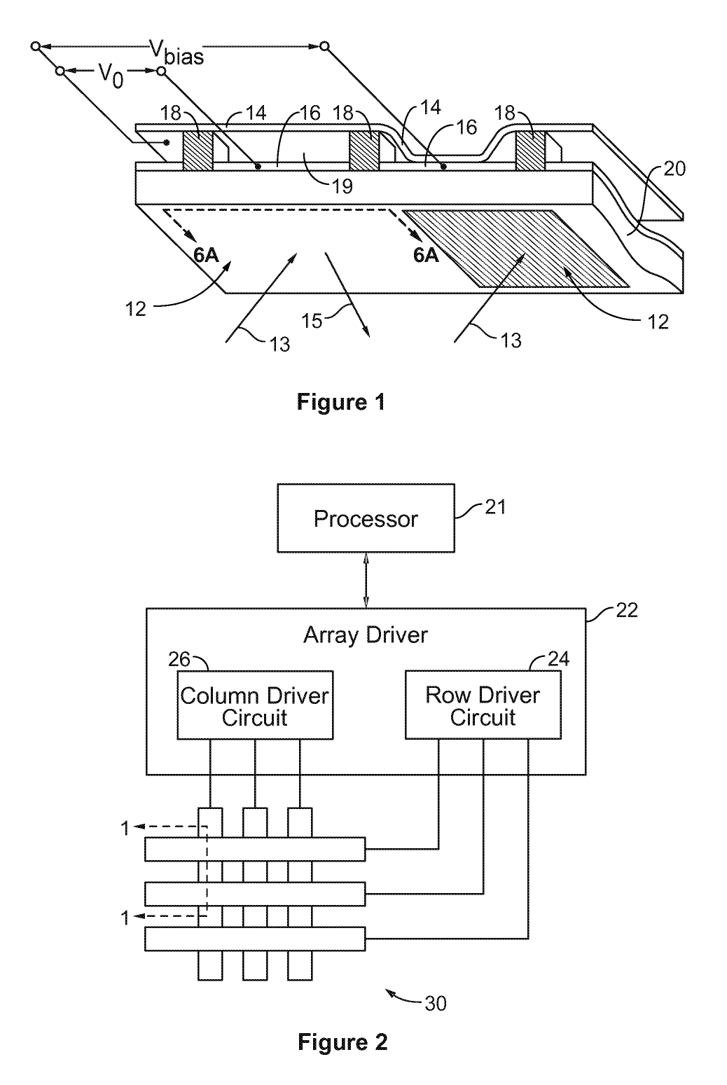

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (e.g., of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

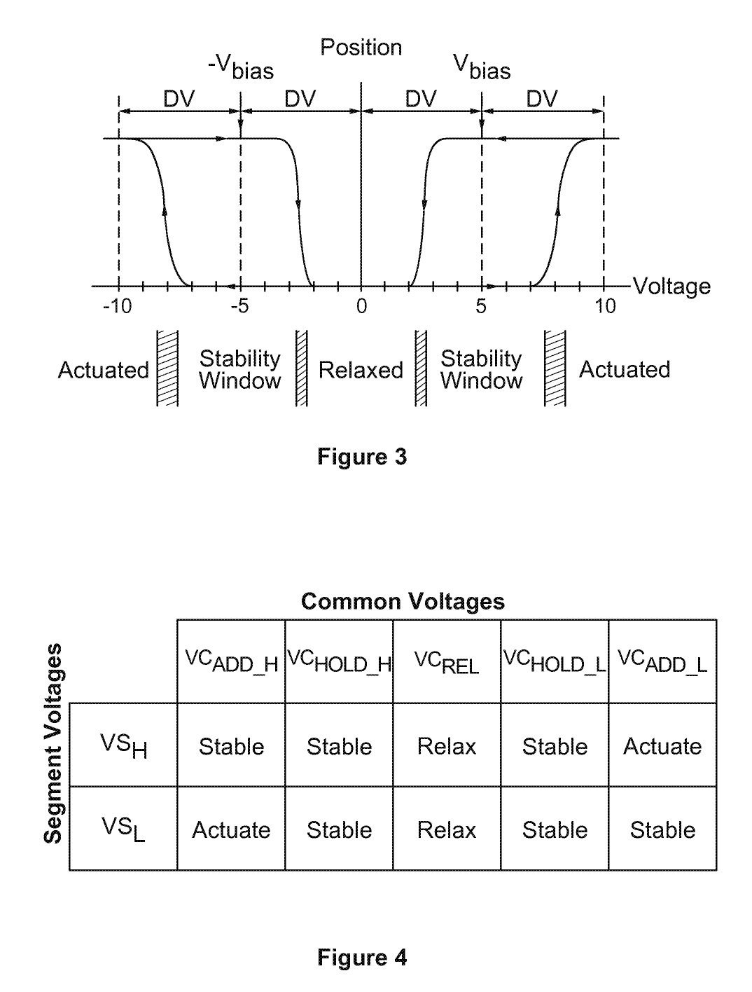

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

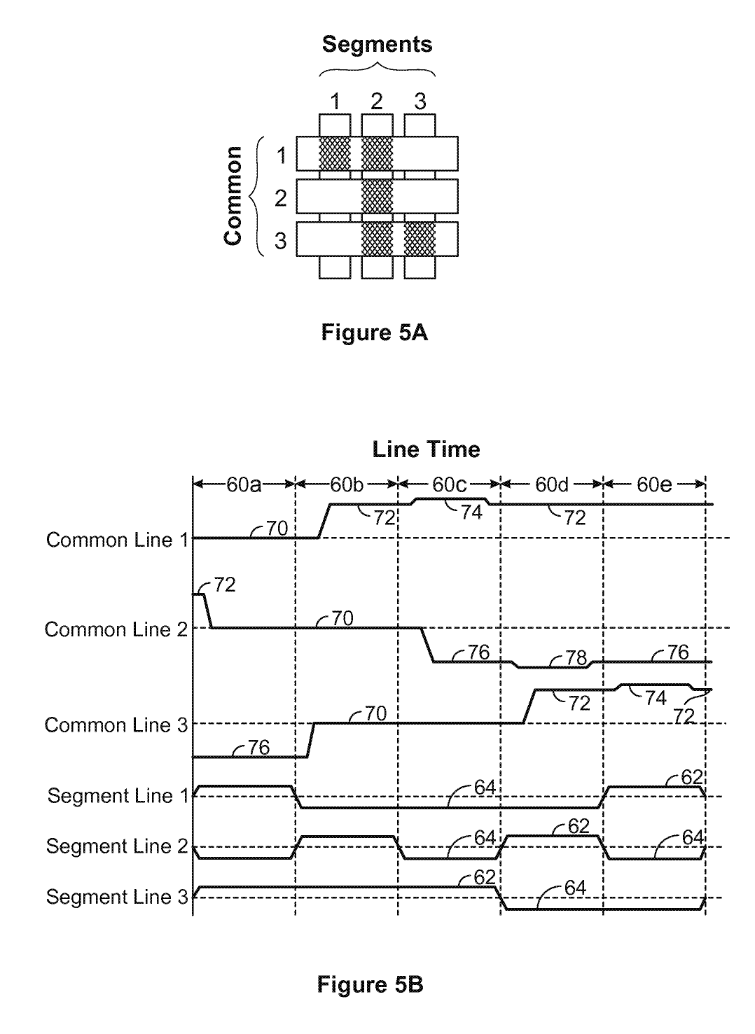

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

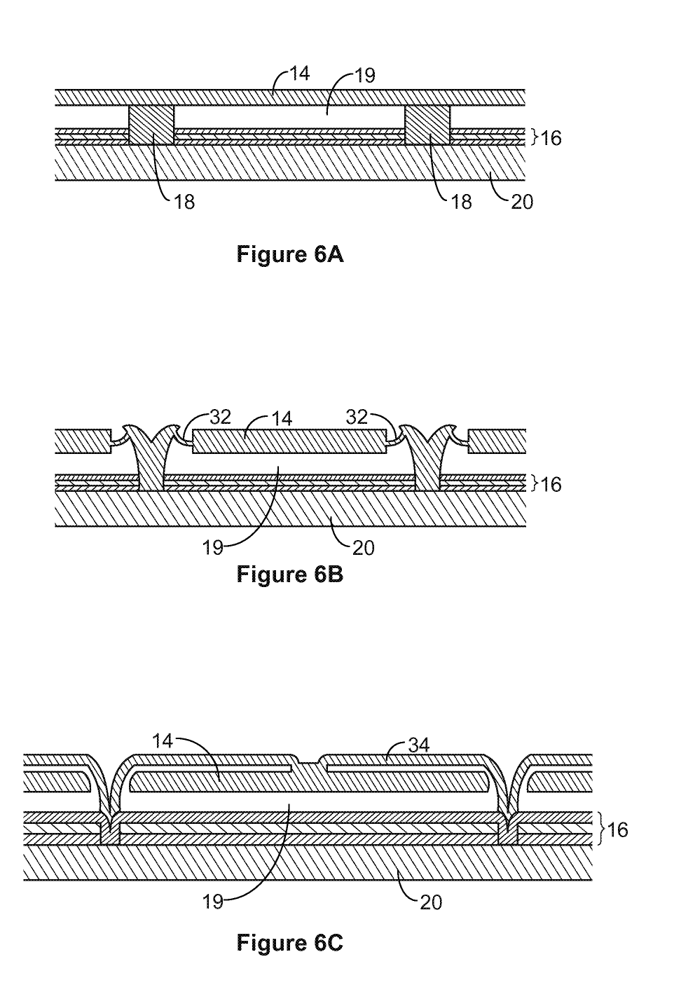

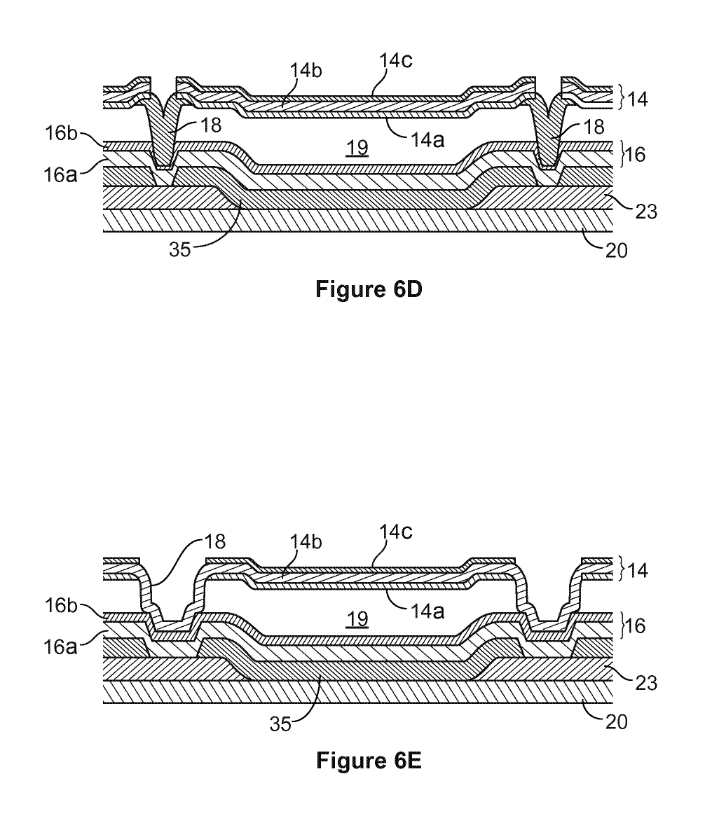

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (such as between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ or other dielectric layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

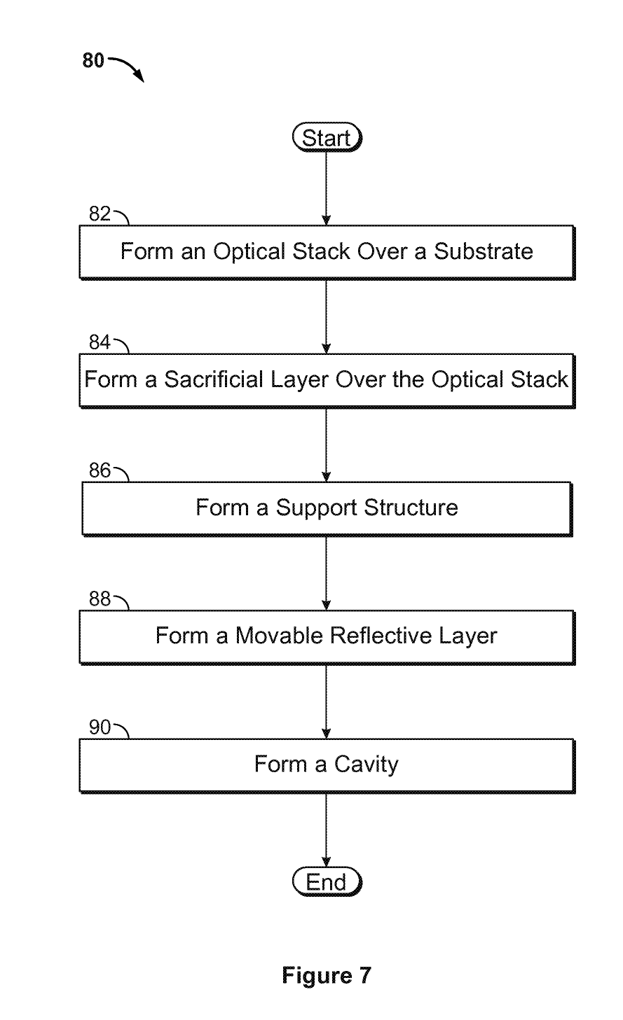

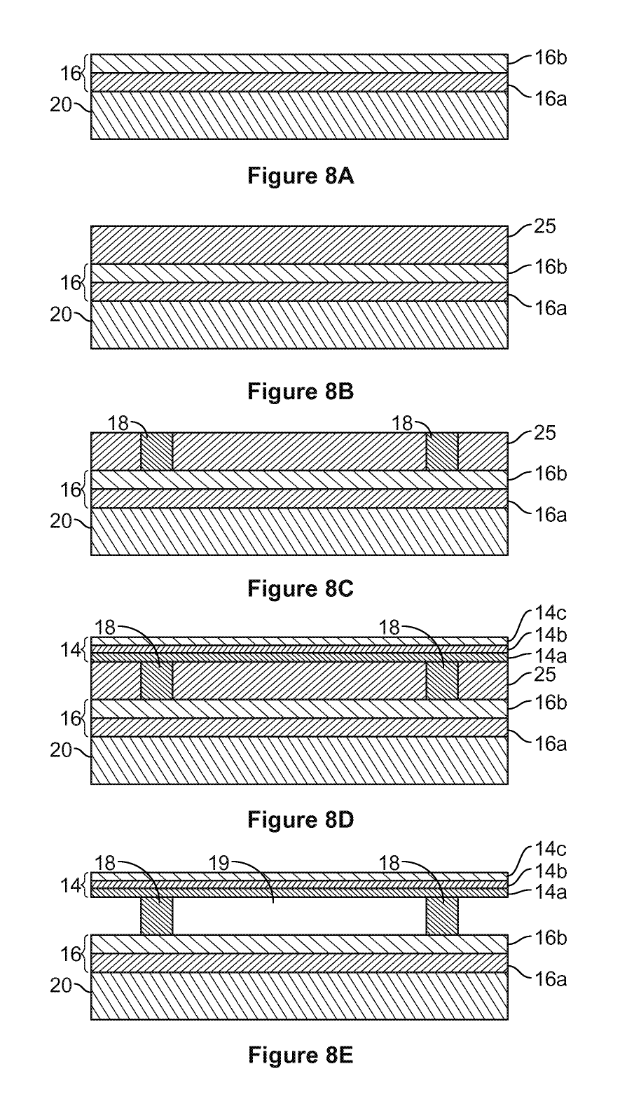

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (such as a polymer or an inorganic material such as silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps including, for example, reflective layer (such as aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, such as cavity 19 illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

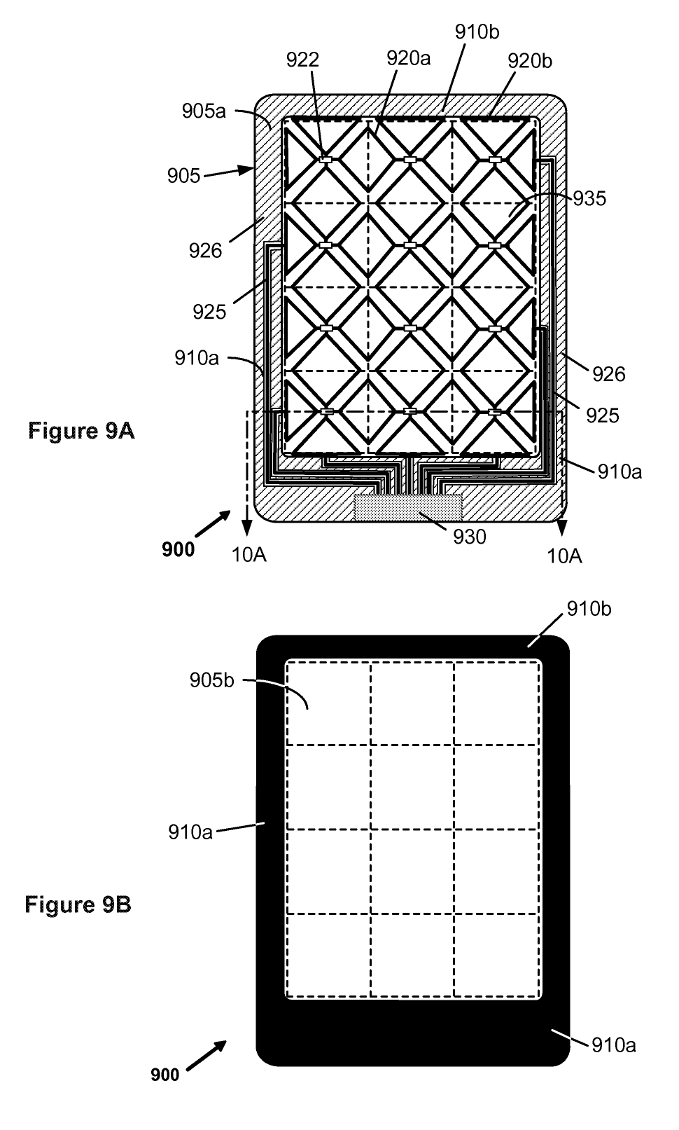

FIG. 9A shows an example of a display-side view of a substrate having touch sensor electrodes and routing wires formed thereon. The touch sensor device 900 includes sensor electrodes 920a and 920b disposed upon a side 905a of a substrate 905. As noted elsewhere herein, the substrate 905 may be formed of any suitable substantially transparent material, such as a type of glass, a polymer, etc. The substrate 905 may have coatings for desired functionality, such as an antireflection coating, an antiglare coating, an anti-fingerprint coating, etc. In some such implementations, the sensor electrodes 920a and 920b may be formed the side 905a of the substrate 905 and one or more such coatings may be formed on an opposing side of the substrate 905.

The sensor electrodes 920a and 920b may include a substantially transparent conductor. In this implementation, the sensor electrodes 920a and 920b are formed of indium tin oxide (ITO). In this example, the sensor electrodes 920a are row electrodes and the sensor electrodes 920b are column electrodes. The jumpers 922 connect discontinuous portions of the sensor electrodes 920a, providing a continuous electrical connection across each row. The jumpers 922 may include a dielectric layer in order to prevent an electrical connection with the sensor electrodes 920b. In some implementations, the sensor electrodes 920a and 920b are formed of static IMODs similar to those described further below. In such implementations, the sensor electrodes 920a and 920b include a partially reflective layer, an oxide layer, for example a non-conducting or a conducting oxide, and a conductive layer (which can also be reflective).

In the illustrated implementation, the sensor electrodes are formed into diamond shapes. However, in other implementations the sensor electrodes 920a and 920b may be formed into other shapes, such as triangles, loops, etc. In this example, the touch sensor device 900 includes seven (7) sensor electrodes 920a and 920b, three (3) in one direction and four (4) in another direction. Other implementations may include other numbers of sensor electrodes 920a and 920b. Some implementations, for example in a relatively small hand-held device, may include 30 or so more electrodes 920a and 920b. It is understood, however, that the number of electrodes 920a and 920b will depend upon the size of the touch sensor device 900 and the desired resolution for a given implementation. In some such implementations, the sensor electrodes 920a and 920b may be formed into polygons having sides that are in the range of 1 to 10 millimeters in length.

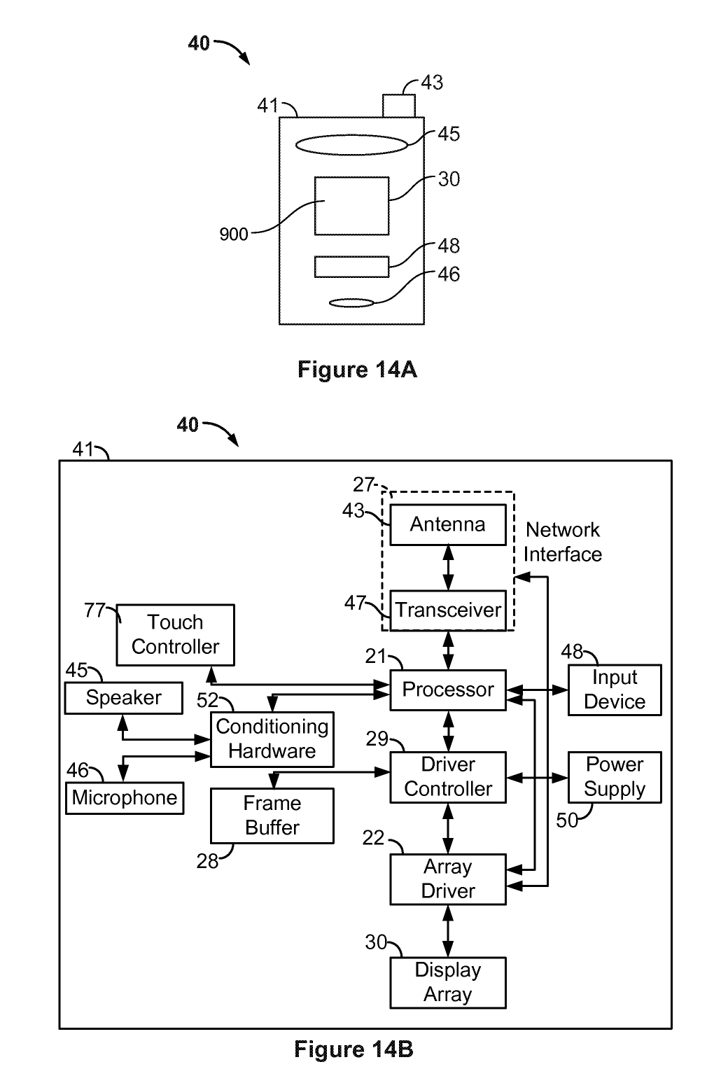

Routing wires 925 may be seen around the periphery of the touch sensor device 900. In this example, the routing wires 925 are formed in the border areas 910a. The routing wires 925 form an electrical connection between control circuitry and each row and column of the sensor electrodes 920a and 920b. Here, the routing wires 925 form an electrical connection between a flex cable 930 and the sensor electrodes 920a and 920b. The flex cable 930 may be configured for electrical communication with a touch controller, such as touch controller 77 shown in FIG. 14B and described below. In some implementations, the touch controller 77 may be formed directly on the substrate 905. The routing wires 925 may be interferometrically masked using static IMODs as described below in greater detail. The border areas 910a may also include a patterned mask 926 that is made of the same kind of static IMOD structure as the routing wires 925. However, the patterned mask 926 may be patterned so as not to short with the routing wires 925. In some implementations, the static IMODs that form the patterned mask 926 are not electrically connected with any of the sensor electrodes 920a or 920b.

In this implementation, the routing wires have been formed by depositing optical cavity layers on the substrate 905, to form static IMODs. Examples of these static IMODs will be described in more detail below. The border area 910b does not include the routing wires 925 in this example. However, in some implementations, static IMODs electrically isolated from the routing wires 925 may be formed both in the border areas 910a and in the border area 910b, such as the patterned mask 926 shown in FIG. 9A.

In the example shown in FIG. 9A, the touch sensor device 900 is configured to detect changes in capacitance caused by proximity of a finger, a conductive stylus, etc., to the substrate 905. By detecting changes in mutual capacitance between the sensor electrodes 920a and 920b (or changes in self capacitance of individual sensor electrodes 920a and 920b), the touch sensor device 900 can determine a location of the finger, conductive stylus, etc. Such a determination may be made by a device such as touch controller 77, which is described below with reference to FIG. 14B. Alternatively, such a determination may be made (at least in part) by another device, such as a controller of a device to which the touch sensor device 900 is attached, such as the processor 21 of FIG. 14B.

In some implementations, when a finger touches (or is brought near) the touch sensor device 900, the finger may overlap more with a particular sensor element 935 and less with an adjacent sensor element 935. By probing various sensor elements 935 in an area of a finger touch, for example, the touch controller may be configured to determine changes in capacitance between the sensor elements 935 in the area. In some implementations, the touch controller may be configured to determine a touch centroid according to the combined effect of these changes in capacitance. In some implementations, the touch controller may be configured to represent these changes as a Gaussian envelope to determine a touch location.

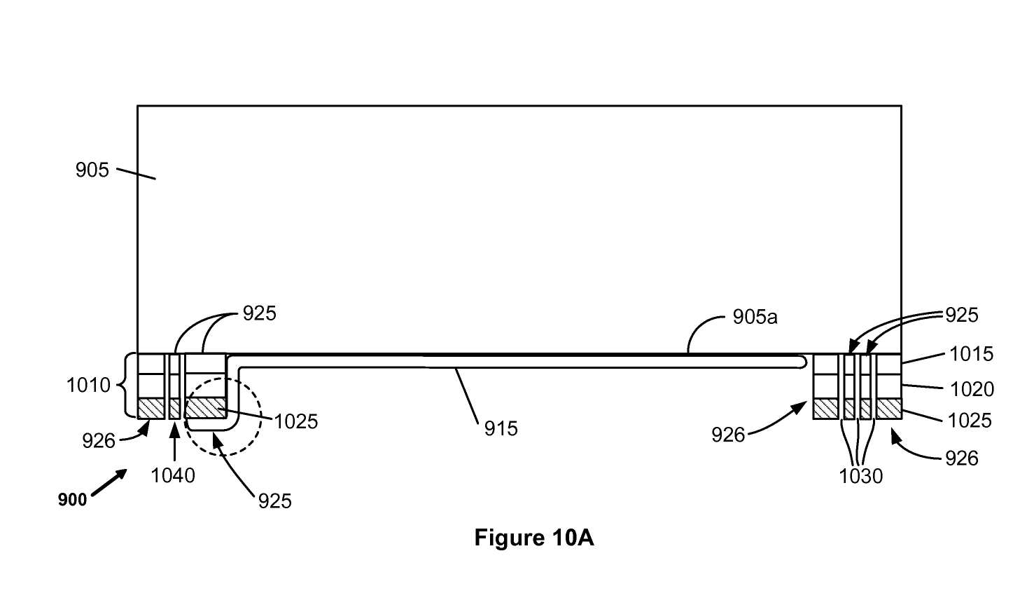

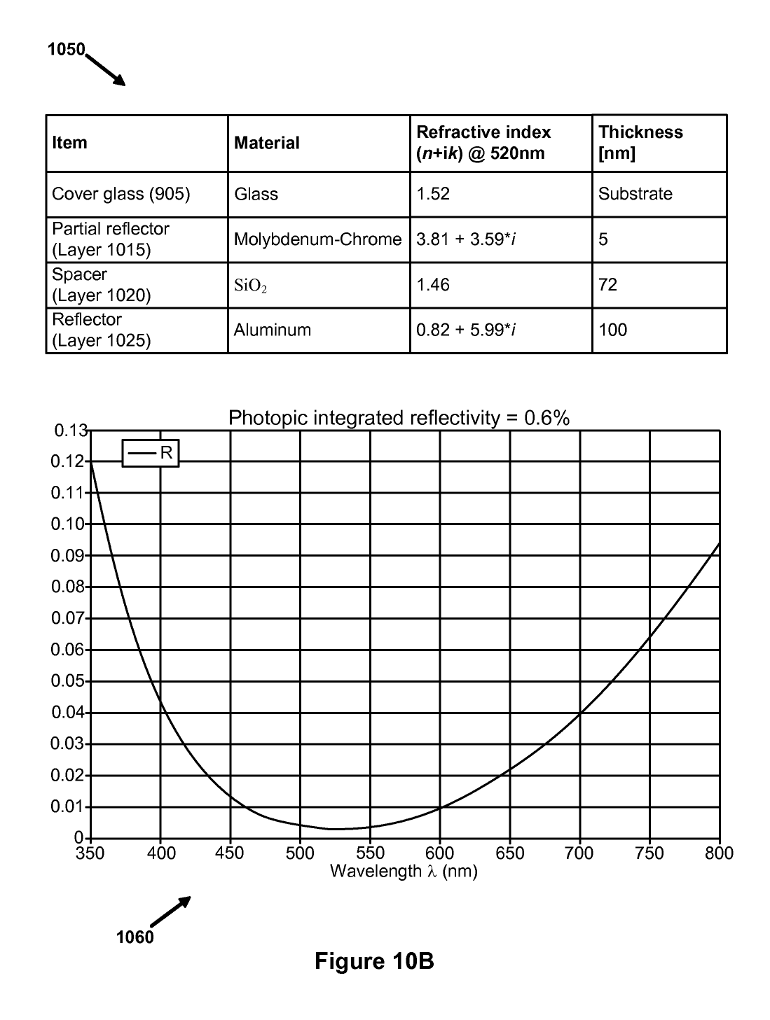

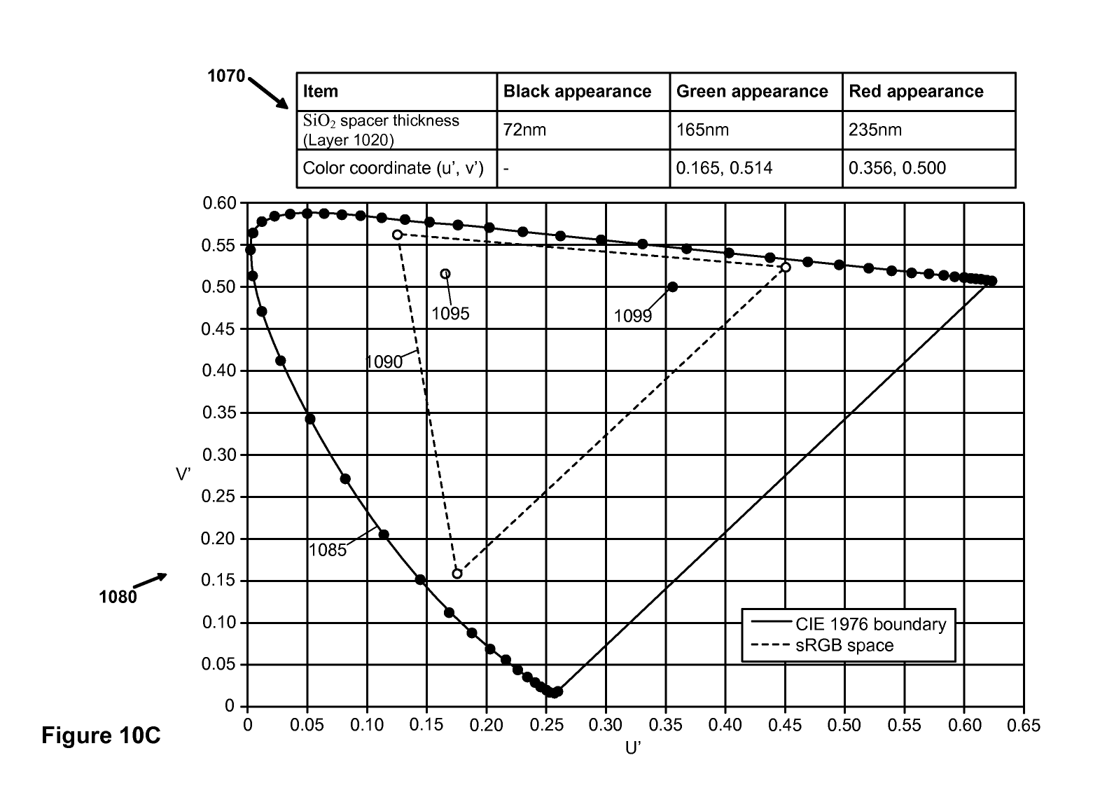

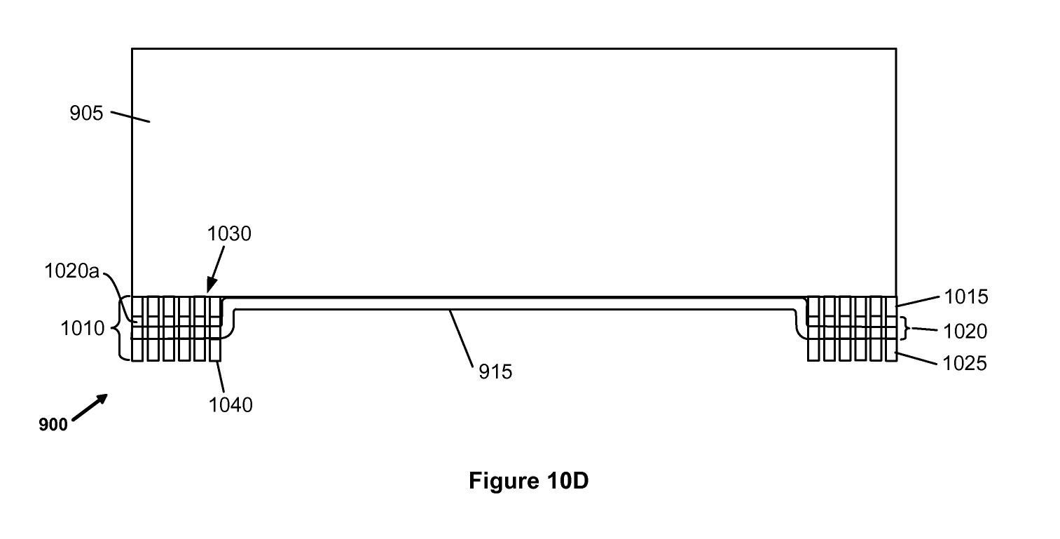

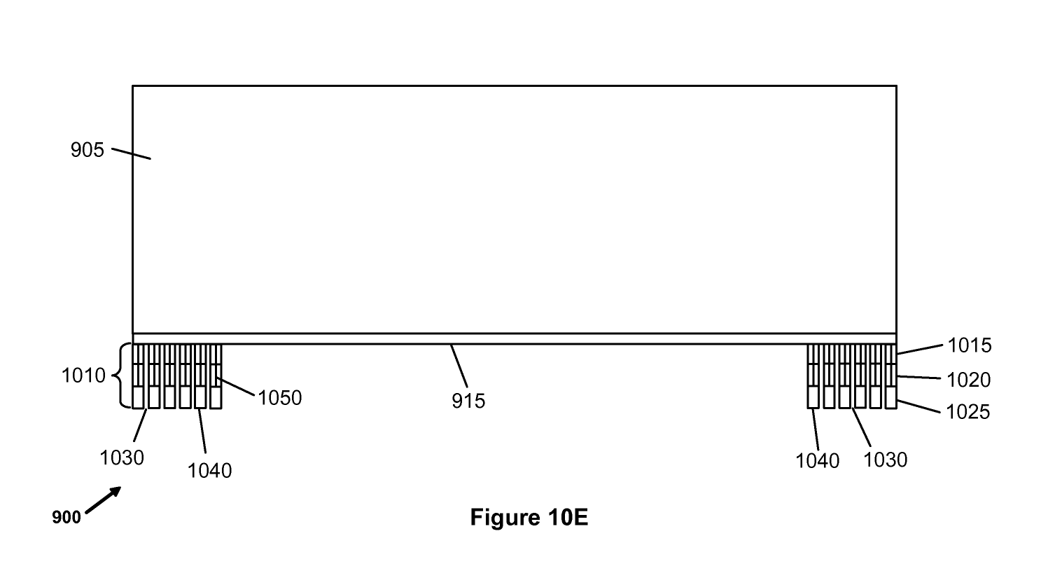

FIG. 9B shows an example of a view of a substrate from a side that is opposite to the side shown in FIG. 9A. FIG. 9B depicts the touch sensor device 900 from a side 905b that is opposite the side 905a. In some implementations, the side 905b may be an exterior side of the substrate that is visible to a viewer after the touch sensor device 900 is attached to a display device. In this example, static IMODs form a solid color in border areas 910a and 910b. The gaps (see gaps 1050 and 1052 in FIG. 10A) between electrically isolated static IMODs may be minimally visible to the eye of a viewer at about 16 inches or more, as will be described in greater detail below. In other examples, static IMODs may form a multi-colored border area.

FIG. 10A shows an example of a cross-section through a substrate having static IMODs in a border area and an overlapping touch sensor electrode layer. The cross-section shown in FIG. 10A is made along line 10A-10A of FIG. 9A. The structure shown in FIG. 10A includes substrate 905, static IMODs formed into routing wires 925 and patterned mask 926, and touch sensor electrode layer 915. The substrate 905 may be formed of glass, plastic or any other suitable substantially transparent material.

In this example, the static IMODs 1010, such as routing wires 925 and patterned mask 926, are formed in border areas of the substrate 905 and include a partially reflective layer 1015, an transparent layer 1020 and a layer 1025, which may be formed of reflective and conductive material. The partially reflective layer 1015 may function as an optical absorber layer, as described above. In some implementations, the partially reflective layer 1015 may be made of material that is at least partially conductive. For example, the partially reflective layer 1015 may be formed of molybdenum-chromium (MoCr) with a thickness in the range of about 30-80 Å. In alternative examples, the partially reflective layer 1015 may be formed of other materials, such as Mo, Cr, germanium (Ge), lead selenide (PbSe), etc. In some implementations, partially reflective layer 1015 includes any material with an extinction coefficient between 0.1 and 10.

The transparent layer 1020 may be formed of any suitable substantially transparent material. The transparent layer 1020 may, for example, include an SiO₂ layer with a thickness selected to reinforce a desired wavelength of visible light. In some implementations, the transparent layer 1020 may include a conductive oxide layer. In some implementations, the transparent layer 1020 includes indium tin oxide (ITO) and zinc oxide (ZnO).

In some implementations, the layer 1025 may be formed of a reflective and conductive material, such as Mo, Cr, Ni, Al, alloys thereof, etc. In implementation, the transparent layer 1020 is an Al layer with a thickness in the range of about 500-1,000 Å, which is thick enough to reflect most incident light.

A touch sensor electrode layer 915 for the touch sensor may be formed of a substantially transparent conductive material such as indium tin oxide (ITO). In this example, the touch sensor electrode layer 915 overlies, and is configured for electrical communication with, the layer 1025 of one of the routing wires as shown in the dotted circle. Accordingly, layer 1025 may function both as a reflector for the static IMODs 1010 and as a routing layer for individual electrodes of the touch sensor electrode layer 915. Because the touch sensor electrode layer 915 overlies the layer 1025 in this example, there is no need to form conductive vias through non-conductive layers of the IMODs 1010 in order to form an electrical connection between the layer 1025 and the touch sensor electrode layer 915. While cross-section 10A-10A of FIG. 9A includes the jumpers 922 and patterned sensor electrodes 920a, it is understood that FIG. 10A only shows touch sensor electrode layer 915 schematically for ease of illustration.

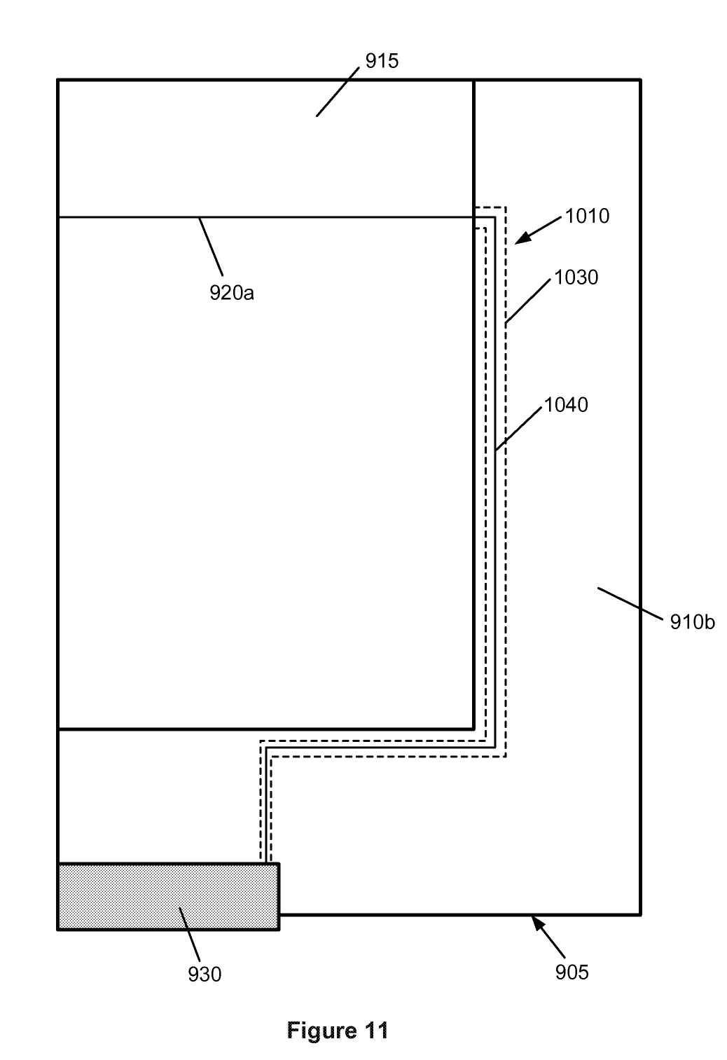

Here, cuts 1030 have been formed in the static IMODs 1010 in order to isolate each of the traces 1040 that make up routing wires 925. Cuts can also separate patterned mask 926 from the traces 1040. The geometry of one of the traces 1040 may be seen more clearly in the example shown in FIG. 11, below. In alternative implementations, the cuts 1030 may extend through the layer 1025, but may not extend through the transparent layer 1020 or the partially reflective layer 1015. Cuts 1030 may be formed by masking the static IMODs 1010 and etching exposed lines or patterns to form cuts 1030. In some such implementations, the partially reflective layer 1015 may be grounded to shield the traces 1040. For example, the partially reflective layer 1015 may be grounded to the layer 1025 of a patterned mask 926 that is not electrically connected to any of the traces 1040. In some such implementations, the partially reflective layer 1015 (but not the layer 1025) may be continuous between at least one of the traces 1040 and the patterned mask 926. A conductive via may extend through the transparent layer 1020 and electrically connect the partially reflective layer 1015 and the layer 1025 in the patterned mask 926.

In yet other implementations, layer 1025 may be reflective but not conductive, such as a dielectric stack. In such implementations, the cuts 1030 may extend through the layer 915, in order to isolate traces 1040. However, the cuts 1030 do not need to extend though the layer 1025 if it is not a conductive layer. In such implementations, the traces 1040 can include material used to form the layer 915, for example transparent layer 1020. If this material is ITO or a similar material, the resistance of such traces 1040 may be substantially higher than the resistance of the traces 1040 in implementations for which the IMODs 1010 include a layer of highly conductive material. It is also noted that while the discussion of the static IMODs 1010 herein are generally directed towards reflective IMODs, in some implementations, the IMODs 1010 can be transflective (partially transmissive, and partially reflective). In such cases, layer 1025 can be both conductive and partially reflective. In some implementations, layer 1025 can be a layer of Al that is less than 30 nm thick, for example, less than 20 nm thick.

In some implementations, the cuts 1030 may be made sufficiently narrow that they are not noticeable to a human viewer. For example, the cuts 1030 may be made only a few microns in width, e.g., 1 to 10 microns in width. In some implementations, the cuts 1030 are less than 15 microns. In alternative implementations, the cuts 1030 may be made between 15 and 100 microns in width, or could even be made wider. In some such implementations, the cuts 1030 may be visible to a human observer. In such implementations, the cuts 1030 may be considered part of the design of the border regions 910a and 910b.

In some implementations, a static image may be formed in the border regions 910a and 910b. In such an implementation, the traces 1040 and the patterned mask 926 in the border regions 910a and 910b may be divided into a plurality of pixels of static IMODs. As illustrated in the example of FIG. 10A, the widths of the traces 1040 are co-extensive with the widths of individual pixels or subpixels: the width of each trace 1040 is the same as the width of each of the corresponding static IMODs 1010. However, in other implementations the widths of the traces 1040 may or may not be co-extensive with the widths of individual static IMODs 1010. There may be multiple static IMODs 1010 in each trace 1040 or vice versa. Implementations that include intricate patterns or other decorations in the border areas, for example, may include multiple static IMODs 1010 within each trace 1040.

Similarly, the patterned mask 926 can include multiple static IMODs 1010. Different static IMODs corresponding to different colors can differ in the thickness of the transparent layer 1020. The pixelation may be achieved by pixelating one of or both of the partially reflective layer 1015 and the transparent layer 1020, while the 1025 is left continuous. Such an implementation can be useful when signals on traces 1040 are routed in the layer 1025. In alternative implementations, the pixelation may be achieved by pixelating the transparent layer 1020 and the layer 1025, while the partially reflective layer 1015 is left continuous. Such an implementation can be useful when signals on the traces 1040 are routed in the partially reflective layer 1015.

The thickness of the layer 1020 in each subpixel may form an optical cavity that reinforces a wavelength range or color of incident light. In some examples, the thickness of the optical cavity may be such that the “color” is black. Implementations that include a variety of colors in the border areas may include multiple static IMODs 1010 in each trace 1040 and/or patterned mask 926. In some such implementations, each of the static IMODs 1010 may correspond with a subpixel. Such implementations may, for example, use groups of subpixels to form a single pixel having a single color. The subpixels within a pixel may, for example, be red, green and blue subpixels. However, these subpixels may be combined via color mixing to produce a pixel having any of a wide variety of colors.

FIG. 10B shows an example of a graph of the spectral response of a static IMOD 1010 configured to produce a black appearance. FIG. 10B also shows examples of materials that may be used for such an IMOD, their refractive indices (n+ik) at 520 nm and their thicknesses. In this example of a reflective IMOD implementation, the table 1033 includes a substrate formed of glass having a refractive index of 1.52. The partially reflective layer 1015 is formed of MoCr having a refractive index of 3.81+3.59i and a thickness of 5 nm. The transparent layer 1020 is formed of SiO₂ having a refractive index of 1.46 and a thickness of 72 nm. The layer 1025 is formed of Al having a refractive index of 0.82+5.99i and a thickness of 100 nm. These material types and thicknesses are only made by way of example. Other materials and material thicknesses may be used to provide a similar optical effect.

The reflectivity of this optical cavity is shown in the graph 1060. Here, the reflectivity is shown over a wavelength range from 350 nm to 800 nm. The integrated reflectivity across this wavelength range is approximately 0.6%. Accordingly, the optical cavity has a very low reflectivity, producing a black appearance.

However, in some other implementations, the thickness of the transparent layer 1020 may be selected such that a static IMOD 1010 will reinforce another color, such as blue, green, etc. FIG. 10C shows an example of a graph of color coordinates of optical cavity layers configured to reinforce a red color and a green color. FIG. 10C also includes the table 1070, which indicates thicknesses of layer 1020 for producing optical cavity layers configured to produce a black, green or red appearance. In this example, a thickness of 165 nm is noted to produce a green appearance and a thickness of 235 nm is noted to produce a red appearance.

Color coordinates for the red and green examples are indicated in the table 1070 and shown in the graph 1080. The graph 1080 is based on a color space adopted by the International Commission on Illumination (CIE) in 1976, known as the CIE 1976 (L*, u*, v*) color space, also known as the CIELUV color space. The curve 1085 indicates the boundary for the CIELUV chromaticity diagram. The triangle 1090 indicates the boundary of the sRGB color space, which is a widely-used RGB color space designed to be applicable to typical home and office viewing conditions. In this example, an optical cavity in which the transparent layer 1020 has a thickness of 165 nm has color coordinates of 0.165, 0.514, which correspond to location 1095 within the green region of the sRGB color space. An optical cavity in which the partially reflective layer 1015 has a thickness of 235 nm has color coordinates of 0.356, 0.500, which correspond to location 1099 within the red region of the sRGB color space. Other thicknesses of the transparent layer 1020 may be used to form optical cavities that reinforce other colors. As noted above, the static IMODs 1010 may act as subpixels in some implementations. The colors reinforced by groups of such subpixels may be combined to produce pixels having any of a wide variety of colors.

FIG. 10D shows a generic example of a cross-section through a substrate having static IMODs in a border area and a touch sensor electrode layer incorporated into an optical cavity layer of the static IMODs. In this example, the touch sensor electrode layer 915 forms at least part of the transparent layer 1020. Accordingly, the static IMODs 1010 overlap the touch sensor electrode layer 915. Here, the touch sensor electrode layer 915 forms only part of the transparent layer 1020 and is configured for electrical communication with the layer 1025. However, another part of the transparent layer 1020 (shown as the sub-layer 1020a in FIG. 10D) is formed of a dielectric, such as SiO₂. Although a single touch sensor electrode layer 915 is schematically illustrated extending across the traces 1040, it is understood that individual traces 1040 would be electrically isolated and that touch sensor electrode layer 915 would connect to routing wires 925 and traces 1040 as indicated in FIGS. 9A and 10A.

In this example, the color reinforced by the static IMODs 1010 will be determined by the combined thickness of the layer 915 and the sub-layer 1020a. In order to determine the overall thickness of the transparent layer 1020, one could start with a thickness of the layer 915 that is sufficient to provide desired electrical properties. In one example, it may be determined that if the layer 915 is formed of ITO, a thickness of 50 nm may be sufficient to provide a desired resistivity. The additional optical cavity thickness provided by the sub-layer 1020a may be selected to reinforce a desired color. Because the index of refraction of ITO (approximately 1.93 at 546 nm) is greater than that of SiO₂, the overall thickness of the transparent layer 1020 for reinforcing a particular color will be relatively less if an ITO layer forms a portion of the transparent layer 1020 in implementations wherein the transparent layer 1020 is formed only of SiO₂.

In some implementations, the thickness of the layer 915 may be too large for the transparent layer 1020 to reinforce a first order color, such as a first-order blue or green color. In some such implementations, the thickness of the sub-layer 1020a and/or the layer 915 may be selected to reinforce second-order or third-order colors. Such implementations may provide greater color saturation than implementations having optical cavities configured to reinforce only first-order colors.

In the simple example shown in FIG. 10D, the layers 1020 are shown as having substantially the same thickness in all of the static IMODs 1010. However, in other implementations, the thickness of the transparent layer 1020 could vary in order to form optical cavities that reinforce a variety of colors. Such colors could form decorative patterns, images, etc., in the border areas of the substrate 905. Adjacent static IMODs 1010 may act as subpixels, the colors of which may be combined to produce pixels having a wide variety of colors. In some implementations, the overall thickness of the transparent layer 1020 may be varied by depositing varying thicknesses of the sub-layer 1020a while keeping the thickness of the layer 915 substantially constant. This can be useful in implementations wherein maintaining the resistance of the traces 1040 is desirable. However, in alternative implementations, the thickness of the layer 915 may be varied.

FIG. 10E shows an example of a cross-section through a substrate having static IMODs in a border area and overlapping a touch sensor electrode layer. In order to fabricate an implementation such as that shown in FIG. 10E, the touch sensor electrode layer 915 may be deposited on the substrate 905, then the static IMODs 1010 may be formed on the touch sensor electrode layer 915. Accordingly, the static IMODs 1010 overlie the touch sensor electrode layer 915. Optional vias 1050 may be formed in the layers 1015 and 1020 of static IMODs 1010 and filled with conductive material. The conductive material in the vias 1050 allows individual electrodes of the touch sensor electrode layer 915 to be configured for electrical communication with each of the traces 1040. It is understood that traces 1040 can be electrically isolated, and hence touch sensor electrode layer 915 may not extend across all traces 1040 in a single cross-section.

In some alternative implementations, the transparent layer 1020 may include a transparent conductive oxide. If the partially reflective layer 1015 is also conductive, all layers of the IMODs 1010 may be conductive. Some conductive IMOD implementations may not include the conductive vias 1050.

FIG. 11 shows an example of static IMODs forming a routing wire for a touch sensor electrode. In FIG. 11, a portion of the touch sensor electrode layer 915 may be seen, as well as portions of a border area 910b upon which the static IMODs 1010 have been formed. A single border trace 1040a is shown for ease of viewing. The trace 1040 is electrically isolated from the adjacent traces 1040 or patterned mask 926 (not shown) by the cuts 1030. The trace 1040a forms an electrical connection between an individual row electrode 920a of the touch sensor electrode layer 915 and a flex circuit 930, which may in turn be electrically connected with a controller (not shown) for the touch sensor.

Additional traces 1040 may be disposed in the border area 910a. Each of the traces 1040 may be configured to form an electrical connection between an individual electrode 920a or 920b (see FIG. 9A and a flex circuit 930, a touch controller, etc. In some implementations, the additional traces 1040 may be formed on the substrate 905, at the same level as trace 1040a in FIG. 11.

In other implementations, at least some of the traces 1040 may be disposed in different levels, e.g., above or below other traces 1040. Such “stacked” implementations may allow the border area 910b to be relatively narrower than implementations having all of the traces 1040 formed in the same layer of the static IMODs 1010. Some such stacked implementations may include a passivation layer between the stacked traces 1040. In some stacked implementations, the layer 1025 of the static IMODs 1010 may be formed of dielectric material. Moreover, a layer of dielectric material may be formed to electrically isolate an individual electrode 920a or 920b from at least a portion of one of the stacked layers of the static IMODs 1010.

In some stacked implementations, a layer of the static IMODs 1010 may overlap at least some touch sensor electrodes of the touch sensor electrode layer 915, e.g., as shown in FIG. 10E. Such touch sensor electrodes may be configured for electrical connectivity with the layer 1025 of the static IMODs 1010 by conductive vias, such as the vias 1050 of FIG. 10E. However, other touch sensor electrodes of the touch sensor electrode layer 915 may be formed on top of another layer of the static IMODs 1010, such as the touch sensor electrodes that overlap the static IMODs shown in FIG. 10A. Some such touch sensor electrodes may be in direct contact with the layer 1025. In some implementations, additional conductive layers (not shown in FIGS. 10A, 10D, and 10E) may be formed over layer 1025 as additional traces for routing signals to flex cable 930, and a dielectric layer may be disposed between the layer 1025 and the additional conductive layers. At least some of the touch sensor electrodes of the touch sensor electrode layer 915 may be connected to the additional conductive layers.

In stacked implementations, the static IMODs 1010 in the top layer (nearest the substrate 905) may be configured to provide a solid color, a pattern or other decorative effect. In some implementations, the additional stacked layers may be one or more conductive layers (e.g., metal layers) separated from the layer 1025 (and from each other) by dielectric layers.

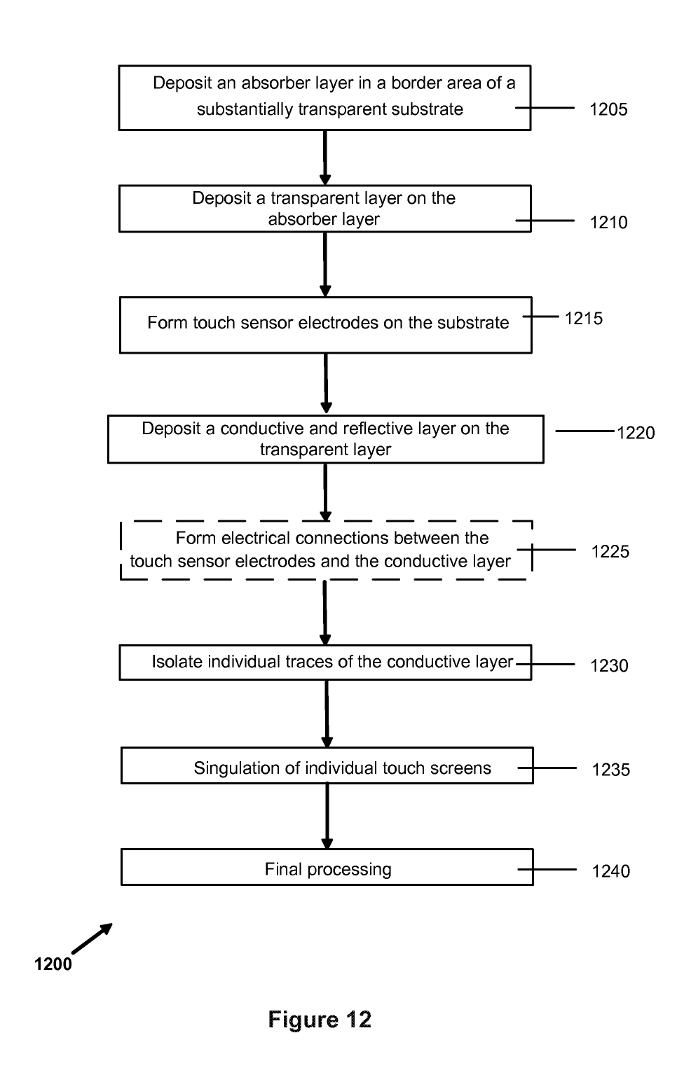

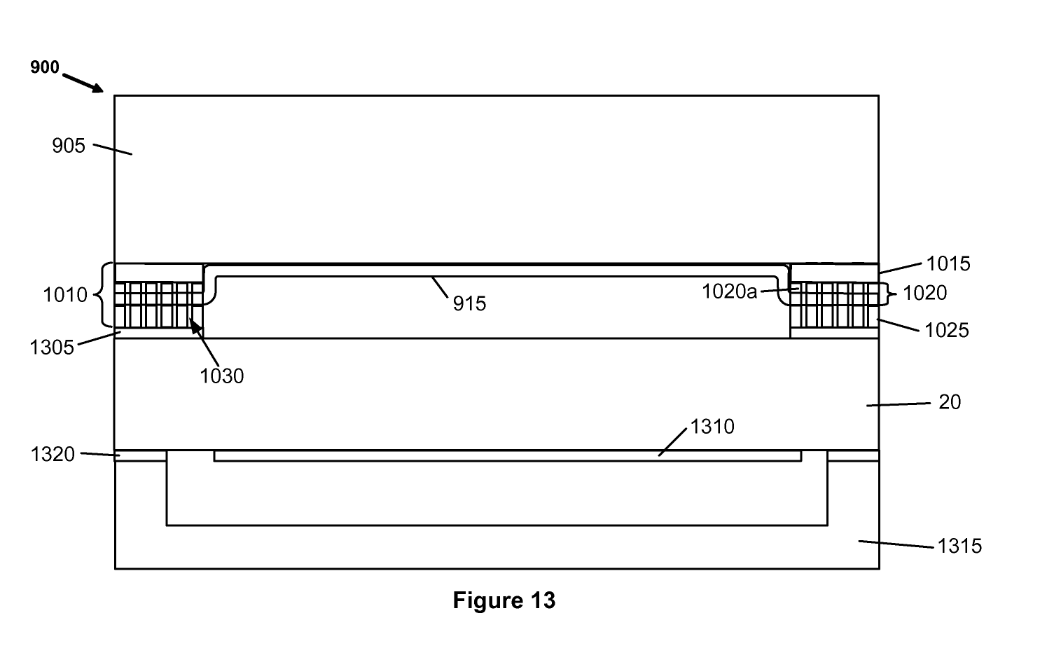

Some device fabrication methods will now be discussed, with reference to FIGS. 10A, 10E, 12 and 13. FIG. 12 shows an example of a flow diagram illustrating a manufacturing process for a touch sensor device. FIG. 13 shows an example of a touch sensor device such as that shown in FIG. 10D mounted on a display glass.

Referring first to FIG. 12, method 1200 begins with a process of depositing an absorber layer in at least a portion of a border area of a substantially transparent substrate (block 1205). In the example of FIG. 13, the absorber layer is the partially reflective layer 1015, which has been deposited on the substrate 905. Although the partially reflective layer 1015 is depicted as being continuous within each border area in FIG. 13, in other implementations the partially reflective layer 1015 (as well as the subsequently-formed layers of the static IMODs 1010) may be patterned into numerous pixels or subpixels. The layers 1015, 1020 and 1025 can be patterned using a variety of techniques, including photolithography and dry etching. For example, carbon tetrafluoromethane (CF₄) and/or oxygen (O₂) may be used for etching the layers 1015 and 1020. Chlorine (Cl₂) and/or boron trichloride (BCl₃) may be used for etching the layer 1025.

As with other methods described herein, the operations of method 1200 are not necessarily performed in the order indicated. For example, in the process of fabricating the implementation of touch sensor device 900 shown in FIG. 10E, the touch sensor electrode layer 915 may be formed on the substrate 905 and the partially reflective layer 1015 may be deposited on the touch sensor electrode layer 915.

Referring again to FIG. 12, a layer of transparent material, such as SiO₂, SiON, etc., is deposited on the absorber layer in block 1210. For example, the oxide sub-layer 1020a may be deposited on the partially reflective layer 1015, as shown in FIG. 13. If the static IMODs 1010 are being patterned into numerous pixels or subpixels, block 1210 may involve depositing a layer of oxide material having varying thicknesses in the pixels or subpixels, according to desired colors to be reinforced.

In block 1215, touch sensor electrodes are formed on the substantially transparent substrate. The touch sensor electrodes may be formed (at least in part) of various conductive materials, such as ITO, metal wire, etc. In implementations wherein the touch sensor electrodes include a transparent conductor, at least a portion of the touch sensor electrodes may be formed on and/or made part of the static IMODs 1010. In the example shown in FIG. 13, the touch sensor electrodes are also formed on the sub-layer 1020a and become part of the transparent layer 1020. Then, the layer 1025 may be formed on the transparent layer 1020 (see block 1220 of FIG. 12). In alternative implementations, the layer 1025 may be formed on the transparent layer 1020 before the touch sensor electrodes are formed. One such example is shown in FIG. 10A. In alternative implementations, block 1215 may involve forming the touch sensor electrode layer on a side of the substantially transparent substrate that is opposite from the side on which the static IMODs 1010 are formed.

In optional block 1225, electrical connections are formed between at least some of the touch sensor electrodes and a conductive layer of the static IMODs. Referring to FIG. 10E, for example, vias 1050 may be formed and filled with a conductive material. However, in implementations such as that shown in FIGS. 10A, 10D and 13, block 1225 may not be necessary because the touch sensor electrodes are already configured to be in contact with a conductive layer of the static IMODs. In stacked configurations, some such electrical connections may be formed by direct contact between some of the touch sensor electrodes and a conductive layer of some of the static IMODs (e.g., as shown in FIG. 10A or 10D), whereas conductive vias may be formed between other touch sensor electrodes and a conductive layer of other static IMODs (e.g., as shown in FIG. 10E).

In block 1230, individual conductive traces are isolated. Block 1230 may involve an etching process or a similar process to form cuts 1030 (see, e.g., FIG. 13). In some implementations, such as those in which the touch sensor electrode layer 915 has been formed on a layer 1025 that is formed of dielectric material, block 1230 may involve isolating only the touch sensor electrode layer 915. In other implementations, block 1230 may involve forming the cuts 1030 through the touch sensor electrode layer 915 and through some or all of the layers of the static IMODs 1010. In the implementation shown in FIG. 10A, for example, the cuts 1030 have been made through the touch sensor electrode layer 915 and all of the layers of the static IMODs 1010. In FIG. 13, the cuts 1030 have been made through the layer 1025, the touch sensor electrode layer 915 and the oxide sub-layer 1020a, but not through the partially reflective layer 1015.

In some implementations, blocks 1205 through 1230 may involve forming numerous touch sensor devices 900 on a single substrate. Accordingly, in this example block 1235 involves singulation of individual touch sensor devices 900, e.g., by a dicing process.

In block 1240, final processing steps may be performed. The singulated touch sensor devices may, for example, be configured with a touch controller such as touch controller 77, described below with reference to FIG. 14B. Block 1240 may involve combining an individual touch sensor device 900 with a portable device, such as the device 40 depicted in FIGS. 14A and 14B.

As shown in FIG. 13, for example, block 1240 may involve affixing the touch sensor device 900 to a substrate 20 of such a display device. In this example, the touch sensor device 900 is affixed to the substrate 20 with an adhesive layer 1305. In FIG. 13, an active IMOD array 1310 has been formed on an opposing side of the substrate 20. In this example, a back glass 1315 has been affixed to the opposing side of the substrate 20 with an adhesive layer 1320. Alternatively, block 1240 may involve packaging individual touch sensor devices 900, e.g., for storage, shipping and/or later assembly.

FIGS. 14A and 14B show examples of system block diagrams illustrating a display device 40 that includes a touch sensor as described herein. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device(s) 48 (including a touch sensor device 900 shown in FIG. 9A), and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The touch sensor device 900 (see FIG. 9A) may be a device substantially as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

In this example, the display device 40 also includes a touch controller 77. The touch controller 77 may be configured for communication with the touch sensor device 900 (see FIG. 9A) and/or configured for controlling the touch sensor device 900. The touch controller 77 may be configured to determine a touch location of a finger, a conductive stylus, etc., proximate the touch sensor device 900. The touch controller 77 may be configured to make such determinations based, at least in part, on detected changes in capacitance in the vicinity of the touch location. In alternative implementations, however, the processor 21 (or another such device) may be configured to provide some or all of this functionality.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen such as touch sensor device 900 (see FIG. 9A), and/or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, in the implementations described above, the touch sensor electrode layer is configured to be part of the static IMODs in the border area, or to extend above or below the static IMODs in the border area. However, in some implementations touch sensor electrodes may be configured to contact an edge of a conductive layer of a static IMOD in a border area. Thus, the claims are not intended to be limited to the implementations shown herein, but are to be accorded the widest scope consistent with this disclosure, the principles and the novel features disclosed herein.

The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a substantially transparent substrate;
a touch sensor electrode layer formed on a first area of the substantially transparent substrate; and
a layer of static interferometric modulators formed on the substantially transparent substrate in a border area along at least one edge of the first area.

2. The apparatus of claim 1, wherein the border area substantially surrounds the first area.

3. The apparatus of claim 1, wherein at least some of the static interferometric modulators are not configured for electrical communication with any electrode of the touch sensor electrode layer.

4. The apparatus of claim 1, wherein at least some of the static interferometric modulators form a plurality of traces, each of the traces being configured for electrical communication with an individual electrode of the touch sensor electrode layer.

5. The apparatus of claim 4, further comprising:
a control system, the control system including a touch controller configured for electrical communication with the plurality of traces.

6. The apparatus of claim 5, further comprising:
a display; and
a memory device, wherein the control system includes a processor configured to process image data, the processor being configured to communicate with the display, with the memory device and with the touch controller.

7. The apparatus of claim 6, further comprising:
a driver circuit configured to send at least one signal to the display; and
a display controller configured to send at least a portion of the image data to the driver circuit.

8. The apparatus of claim 6, wherein the substantially transparent substrate forms a cover over the display.

9. The apparatus of claim 6, further comprising:
an input device configured to receive input data and to communicate the input data to the processor, wherein the input device includes the touch sensor electrode layer.

10. The apparatus of claim 6, further comprising:
an image source module configured to send the image data to the processor.

11. The apparatus of claim 10, wherein the image source module includes at least one of a receiver, a transceiver and a transmitter.

12. The apparatus of claim 1, wherein the touch sensor electrode layer overlies the layer of static interferometric modulators.

13. The apparatus of claim 1, wherein the layer of static interferometric modulators overlaps the touch sensor electrode layer.

14. The apparatus of claim 1, wherein the static interferometric modulators comprise:
a first layer, the first layer being electrically conductive and partially optically absorptive;
a transparent layer forming an optical cavity, wherein a thickness of the transparent layer determines a color of the static interferometric modulator; and
a second layer, the second layer being reflective and conductive.

15. The apparatus of claim 14, wherein the transparent layer is formed of a conductive oxide.

16. The apparatus of claim 14, wherein the touch sensor electrode layer is configured for electrical communication with a first portion of the second layer.

17. The apparatus of claim 16, wherein where the first layer is grounded.

18. The apparatus of claim 17, wherein the first layer is grounded to a second portion of the second layer that is not configured for electrical communication with the touch sensor electrode layer.

19. The apparatus of claim 14, wherein the touch sensor electrode layer forms at least part of the transparent layer.

20. The apparatus of claim 14, wherein the static interferometric modulators are configured to provide a single color.

21. The apparatus of claim 14, wherein the static interferometric modulators include first static interferometric modulators configured to provide a first color and second static interferometric modulators configured to provide a second color.

22. The apparatus of claim 14, wherein the static interferometric modulators are configured to provide a decorative pattern or image.

23. A method, comprising:
forming a touch sensor electrode layer on a first area of a substantially transparent substrate; and
forming a layer of static interferometric modulators on a first side of the substantially transparent substrate in a border area around the first area.

24. The method of claim 23, wherein the touch sensor electrode layer is formed on the first side of the substantially transparent substrate.

25. The method of claim 23, wherein the touch sensor electrode layer is formed on a second side of the substantially transparent substrate, the second side being opposite from the first side.

26. The method of claim 23, wherein forming the layer of static interferometric modulators involves forming a plurality of traces, each of the traces being configured for electrical communication with an individual electrode of the touch sensor electrode layer.

27. The method of claim 26, further comprising:
configuring the substantially transparent substrate as a cover over a display.

28. The method of claim 26, further comprising:
configuring a touch controller for electrical communication with the plurality of traces.

29. The method of claim 28, further comprising:
configuring a display processor for electrical communication with the touch controller.

30. The method of claim 23, wherein forming the layer of static interferometric modulators involves forming a decorative pattern or image.

31. An apparatus, comprising:
a substantially transparent substrate;
a touch sensor electrode formed on a first area of the substantially transparent substrate; and
interferometric masking means for interferometrically masking conductive lines formed in a border area around the first area.

32. The apparatus of claim 31, wherein the interferometric masking means includes a plurality of traces, each of the traces being configured for electrical communication with an individual electrode of the touch sensor electrode means.

33. The apparatus of claim 31, wherein the static interferometric modulator means includes optical cavity means and wherein a thickness of the optical cavity means determines a color of the static interferometric modulator means.
